(19) United States
(12) Patent Application Publication
(10) Pub. No.: US 2007/0216603 A1
(43) Pub. Date: Sep. 20, 2007

(54) Method of driving plasma display apparatus

(76) Inventors: Byung Goo Kong, Seoul (KR); Tae Hyung Kim, Seoul (KR); Seong Hak Moon, Seoul (KR); Jong Woon Kwak, Anyang-si (KR)

Correspondence Address: KED & ASSOCIATES, LLP, P.O. Box 221200, Chantilly, VA, 20153-1200, US

(21) Appl. No.: 11/717,776

(22) Filed: Mar. 14, 2007

(30) Foreign Application Priority Data
Mar. 14, 2006 (KR) 10-2006-0023590

(51) Int. Cl. G09G 3/28

(52) U.S. Cl. 345/60

(57) ABSTRACT

A method of driving a plasma display apparatus is disclosed. In the method, a first pulse of a negative polarity is applied to a scan electrode prior to a reset period. A second pulse is applied to the scan electrode during the reset period. The second pulse gradually rises from a first voltage to a second voltage with a first slop, and then gradually rises from the second voltage to a third voltage with a second slope. The first slope is different from the second slope.

This application claims the benefit of Korean Patent Application No. 10-2006-0023590 filed on Mar. 14, 2006, which is hereby incorporated by reference.

### BACKGROUND

1. Field

This document relates to a display apparatus, and more particularly, to a method of driving a plasma display apparatus.

2. Description of the Related Art

Out of display apparatuses, a plasma display apparatus comprises a plasma display panel and a driver for driving the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) or a mixture of Ne and He, and a small amount of xenon (Xe).

The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

### SUMMARY

In one aspect, a method of driving a plasma display apparatus comprises applying a first pulse of a negative polarity to a scan electrode prior to a reset period, and applying a second pulse to the scan electrode during the reset period, the second pulse gradually rising from a first voltage to a second voltage with a first slop and then gradually rising from the second voltage to a third voltage with a second slope, wherein the first slope is different from the second slope.

In another aspect, a method of driving a plasma display apparatus comprises applying a first pulse of a negative polarity to a scan electrode prior to a reset period, and applying a second pulse gradually rising from a first voltage to a second voltage to the scan electrode during the reset period.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates a plasma display apparatus according to embodiments;

FIG. 2 illustrates one example of the structure of a plasma display panel of the plasma display apparatus according to the embodiments;

FIG. 3 is a timing diagram for illustrating a time-division driving method with one frame being divided into a plurality of subfields;

FIG. 4 illustrates a driving waveform generated by a driving method of a plasma display apparatus according to a first embodiment;

FIG. 5 illustrates a driving waveform generated by a driving method of a plasma display apparatus according to a second embodiment;

FIG. 6 illustrates a driving waveform generated by a driving method of a plasma display apparatus according to a third embodiment; and

FIG. 7 illustrates a driving waveform generated by a driving method of a plasma display apparatus according to a fourth embodiment.

### DETAILED DESCRIPTION OF PREFERRED EMBODIMENTS

Reference will now be made in detail embodiments of the invention examples of which are illustrated in the accompanying drawings.

A method of driving a plasma display apparatus comprises applying a first pulse of a negative polarity to a scan electrode prior to a reset period, and applying a second pulse to the scan electrode during the reset period, the second pulse gradually rising from a first voltage to a second voltage with a first slop and then gradually rising from the second voltage to a third voltage with a second slope, wherein the first slope is different from the second slope.

The first slope may be more than the second slope.

The method may further comprise applying a sustain pulse alternately having a positive voltage and a negative voltage to the scan electrode during a sustain period.

The first pulse may be the sustain pulse having the negative voltage applied to the scan electrode during the sustain period.

The first pulse may be a pre-reset pulse applied to the scan electrode during a pre-reset period prior to the reset period.

The second voltage may be substantially equal to the positive voltage of the sustain pulse.

The first voltage may be substantially equal to a ground level voltage.

A difference between the third voltage and the second voltage may be less than a difference between the second voltage and the first voltage.

A ground level voltage may be applied to a sustain electrode.

A pulse having a predetermined voltage may be applied to an address electrode during the application of the second pulse.

The predetermined voltage may be substantially equal to a data voltage of a data pulse applied to the address electrode during an address period.

A method of driving a plasma display apparatus comprises applying a first pulse of a negative polarity to a scan electrode prior to a reset period, and applying a second pulse gradually rising from a first voltage to a second voltage to the scan electrode during the reset period.

The first voltage may be substantially equal to a ground level voltage.

The method may further comprise applying a sustain pulse alternately having a positive voltage and a negative voltage to the scan electrode during a sustain period.

The first pulse may be the sustain pulse having the negative voltage applied to the scan electrode during the sustain period.

The first pulse may be a pre-reset pulse applied to the scan electrode during a pre-reset period prior to the reset period.

A ground level voltage may be applied to a sustain electrode.

A pulse having a predetermined voltage may be applied to an address electrode during the application of the second pulse.

The predetermined voltage may be substantially equal to a data voltage of a data pulse applied to the address electrode during an address period.

Hereinafter, exemplary embodiments of the present invention will be described in detail with reference to the attached drawings.

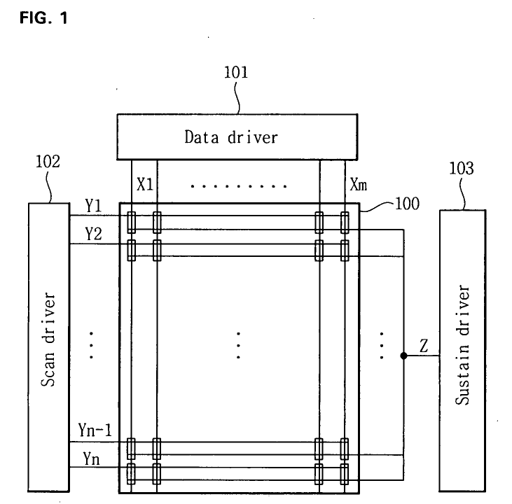

FIG. 1 illustrates a plasma display apparatus according to embodiments.

Referring to FIG. 1, the plasma display apparatus according to the embodiments includes a plasma display panel 100 and a driver for applying a predetermined driving voltage to electrodes of the plasma display panel 100. The driver includes a data driver 101, a scan driver 102, and a sustain driver 103.

The scan driver 102 and the sustain driver 103 may correspond to a first driver. The data driver 101 may correspond to a second driver.

The plasma display panel 100 includes a front panel (not illustrated) and a rear panel (not illustrated) which are coalesced at a given distance therebetween, and a plurality of electrodes. The plurality of electrodes include scan electrode Y1 to Yn, sustain electrodes Y, and address electrodes X1 to Xn.

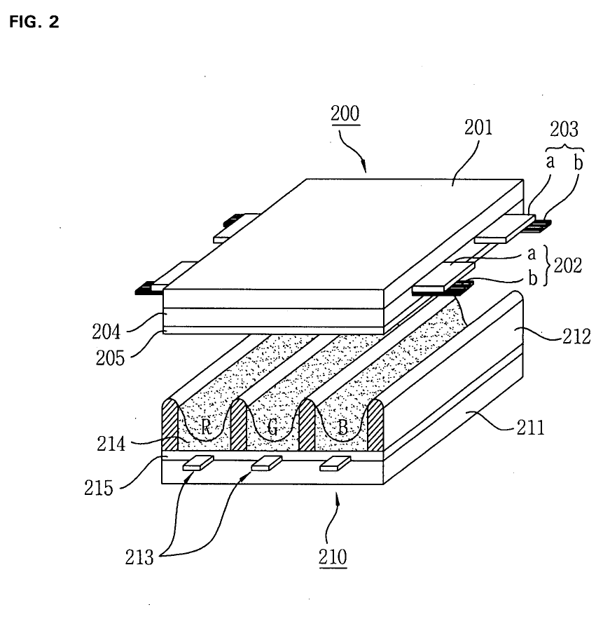

The following is a detailed description of the structure of the plasma display panel 100 with reference to FIG. 2.

As illustrated in FIG. 2, the plasma display panel 100 of the plasma display apparatus according to the embodiments includes a front panel 200 and a rear panel 210 which are coupled in parallel opposite to each other at a given distance therebetween. The front panel 200 includes a front substrate 201 being a display surface on which an image is displayed. The rear panel 210 includes a rear substrate 211 constituting a rear surface. A plurality of scan electrodes 202 and a plurality of sustain electrodes 203 are formed on the front substrate 201. A plurality of address electrodes 213 are arranged on the rear substrate 211 to intersect the scan electrodes 202 and the sustain electrodes 203.

The scan electrode 202 and the sustain electrode 203 each include transparent electrodes 202a and 203a made of transparent indium-tin-oxide (ITO) material, and bus electrodes 202b and 203b made of a metal material. The scan electrode 202 and the sustain electrode 203 generate a mutual discharge therebetween in one discharge cell, and maintain light-emissions of the discharge cells.

The scan electrode 202 and the sustain electrode 203 are covered with one or more upper dielectric layers 204 for limiting a discharge current and providing insulation between the scan electrode 202 and the sustain electrode 203. A protective layer 205 with a deposit of MgO is formed on an upper surface of the upper dielectric layer 204 to facilitate discharge conditions.

A plurality of stripe-type (or well-type) barrier ribs 212 are arranged in parallel on the rear substrate 211 of the rear panel 210 to form a plurality of discharge spaces (i.e., a plurality of discharge cells). The plurality of address electrodes 213 for performing an address discharge to generate vacuum ultraviolet rays are arranged in parallel to the barrier ribs 212.

An upper surface of the rear panel 210 is coated with Red (R), green (G) and blue (B) phosphors 214 for emitting visible light for an image display during the generation of the address discharge is performed. A lower dielectric layer 215 is formed between the address electrodes 213 and the phosphors 214 to protect the address electrodes 213.

Although FIG. 2 has illustrated and described only one example of the plasma display panel applicable to the embodiments, the embodiments are not limited to the structure of the plasma display panel illustrated in FIG. 2.

For example, FIG. 2 has illustrated the scan electrode 202 and the sustain electrode 203 each including the transparent electrode and the bus electrode. However, at least one of the scan electrode 202 and the sustain electrode 203 may include either the bus electrode or the transparent electrode.

Further, FIG. 2 has illustrated and described the structure of the plasma display panel, in which the front panel 200 includes the scan electrode 202 and the sustain electrode 203 and the rear panel 210 includes the address electrode 213. However, the front panel 200 may include all of the scan electrode 202, the sustain electrode 203, and the address electrode 213. At least one of the scan electrode 202, the sustain electrode 203, and the address electrode 213 may be formed on the barrier rib 212.

Considering the structure of the plasma display panel of FIG. 2, the plasma display panel applicable to the embodiments has only to include the scan electrode 202, the sustain electrode 203, and the address electrode 210. The plasma display panel may have various structures as long as the above-described structural characteristics are satisfied.

The description of FIG. 2 is completed, and the description of FIG. 1 continues again.

The scan driver 102 supplies a reset pulse during a reset period, a scan pulse during an address period, and a sustain pulse having a positive voltage and a negative voltage during a sustain period to the scan electrode Y of the plasma display panel 100.

The sustain driver 103 supplies a ground level voltage to the sustain electrode Z during the sustain period.

The data driver 101 supplies a data pulse to the address electrode X during the address period.

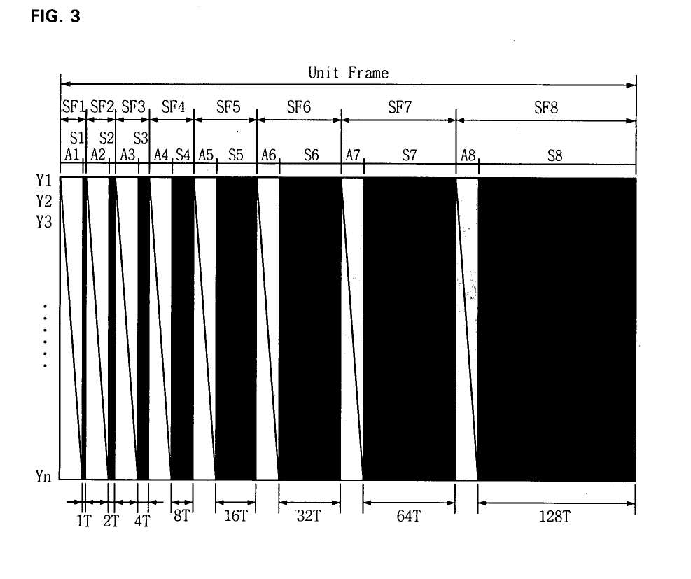

FIG. 3 is a timing diagram for illustrating a time-division driving method with one frame being divided into a plurality of subfields.

As illustrated in FIG. 3, a unit frame may be divided into a predetermined number of subfields, for example, 8 subfields SF1 to SF8 to represent time-division gray scale.

Each of the 8 subfields SF1 to SF8 is divided into a reset period (not illustrated), an address period A, and a sustain period S.

During each of the address periods A1 to A8, data pulses are applied to the address electrodes, and scan pulses corresponding to the data pulses are sequentially applied to the scan electrodes Y1 to Yn.

During each of the sustain periods S1 to S8, sustain pulses having a positive voltage and a negative voltage are applied to the scan electrodes Y1 to Yn, and a ground level voltage is applied to the sustain electrodes. This results in the generation of a sustain discharge inside the discharge cells in which wall charges generated during the address periods A1 to A8 are accumulated.

A luminance of the plasma display panel is proportional to the number of sustain pulses generated during the sustain periods S1 to S8 of the unit frame. For example, if one image with 256 gray levels is to be displayed in the 8 subfields SF1 to SF8, the sustain period increases in a ratio of 2ⁿ (where, n=0, 1, 2, 3, 4, 5, 6, 7) in each subfield. In other words, the sustain period may vary from one subfield to the next subfield.

If a luminance of 133 gray levels is to be represented, the luminance of 133 gray levels is represented by the generation of sustain discharges through the addressing of the discharge cells during the subfields SF1, SF3, and SF8.

The number of sustain discharges assigned to each of the subfields SF1 to SF8 may vary depending on weights of the subfields in accordance with Automatic Power Control (APC).

The number of sustain discharges assigned to each of the subfields SF1 to SF8 may vary in consideration of gamma or panel characteristics.

For example, a gray level assigned to the subfield SF4 may fall from 8 to 6, and a gray level assigned to the subfield SF6 may rise from 32 to 34. Further, the number of subfields constituting one frame may vary according to design specifications.

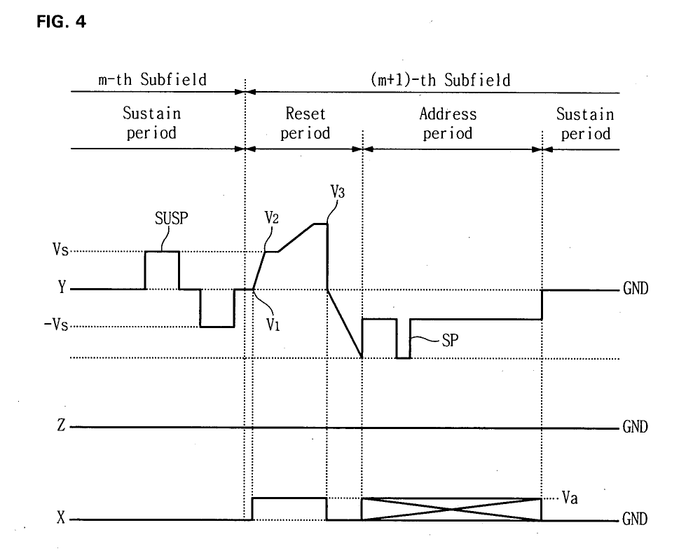

FIG. 4 illustrates a driving waveform generated by a driving method of a plasma display apparatus according to a first embodiment.

As illustrated in FIG. 4, one subfield is divided into a reset period, an address period, and a sustain period.

During the reset period, a rising pulse including a second pulse is applied to the scan electrodes Y. The second pulse gradually rises from a first voltage V1 to a second voltage V2 with a first slope, and then gradually rises from the second voltage V2 to a third voltage V3 with a second slope.

The application of the rising pulse generates a weak discharge such that negative charges are accumulated around the scan electrodes Y. This will be described in detail later.

A falling pulse sharply falling to a ground level voltage GND is applied to the scan electrodes Y, and then the falling pulse falls until a voltage of the scan electrode Y reaches the lowest voltage of the falling pulse.

The application of the falling pulse generates a discharge such that a portion of the negative charges accumulated around the scan electrodes Y is erased.

Accordingly, the remaining negative charges around the scan electrodes Y are uniform to the extent that an address discharge occurs stably. The ground level voltage GND is applied to the sustain electrodes Z and the address electrodes X.

The ground level voltage GND is applied to the sustain electrodes Z all over the address period and the sustain period as well as the reset period. Therefore, a circuit for applying a pulse to the sustain electrodes Z is removed such that the manufacturing cost of a driving circuit is reduced.

During the address period, a scan bias voltage is applied to the scan electrodes Y, and then scan pulses SP having a negative scan voltage are sequentially applied to the scan electrodes Y, thereby selecting cells to be turned on.

Data pulses having a data voltage Va corresponding to the scan pulses SP are applied to the address electrodes X. The ground level voltage GND is constantly applied to the sustain electrodes Z.

The address discharge is performed by the data voltage Va, the scan voltage, a wall voltage caused by negative charges accumulated around the scan electrodes Y, and a wall voltage caused by positive charges accumulated around the address electrodes X.

After performing the address discharge, positive charges are accumulated around the scan electrodes Y, and negative charges are accumulated around the sustain electrodes Z.

During the sustain period, sustain pulses SUSP alternately having a positive sustain voltage Vs and a negative sustain voltage −Vs are applied to the scan electrodes Y. The ground level voltage GND is constantly applied to the sustain electrodes Z.

During the sustain period, an intermediate voltage (i.e., the ground level voltage GND) between the positive sustain voltage Vs and the negative sustain voltage −Vs may be applied to the scan electrodes Y. The application of the intermediate voltage prevents a sharp change in voltages between the positive sustain voltage Vs and the negative sustain voltage −Vs.

When the positive sustain voltage Vs is applied to the scan electrode Y, a sustain discharge is performed by the positive sustain voltage Vs applied to the scan electrode Y, the ground level voltage GND applied to the sustain electrode Z, a wall voltage caused by positive charges accumulated around the scan electrode Y, and a wall voltage caused by negative charges accumulated around the sustain electrode Z. After performing the sustain discharge, negative charges are accumulated around the scan electrode Y, and positive charges are accumulated around the sustain electrodes Z.

When the negative sustain voltage −Vs is applied to the scan electrode Y, a sustain discharge is performed by the negative sustain voltage −Vs applied to the scan electrode Y, the ground level voltage GND applied to the sustain electrode Z, a wall voltage caused by negative charges accumulated around the scan electrode Y, and a wall voltage caused by positive charges accumulated around the sustain electrode Z. After performing the sustain discharge, positive charges are accumulated around the scan electrode Y, and negative charges are accumulated around the sustain electrodes Z.

As above, as the positive sustain voltage Vs and the negative sustain voltage −Vs are alternately applied repeatedly to the scan electrodes Y, a set number of sustain discharges occurs.

In the driving waveform illustrated in FIG. 4, the sustain pulse applied to the scan electrode Y during the sustain period has the positive voltage and the negative voltage, and may end at the negative voltage.

In a case where the sustain discharge ends after applying the positive voltage to the scan electrode Y, negative charges are accumulated around the scan electrode Y and positive charges are accumulated around the sustain electrode Z. Therefore, to initialize a state of wall charges accumulated during the sustain period through a discharge, a rising pulse generated during a reset period is required to have a high voltage.

However, when a sustain pulse generated during a sustain period of an m-th subfield ends at a negative voltage −Vs, positive charges are accumulated around the scan electrode Y and negative charges are accumulated around the sustain electrode Z at a start time point of a reset period of a next (m+1)-th subfield.

In this case, a rising pulse including a second pulse is applied to the scan electrode Y during the reset period. The second pulse gradually rises from a first voltage V1 (for example, the ground level voltage GND) to a second voltage V2 (for example, the sustain voltage Vs) with a first slope, and then gradually rises from the second voltage V2 to a third voltage V3 with a second slope.

As a magnitude of the highest voltage (i.e., the third voltage V3) of the rising pulse is reduced, black light generated by the rising pulse during the reset period decreases.

The first slope may be more than the second slope. A difference between the third voltage V3 and the second voltage V2 may be less than a difference between the second voltage V2 and the first voltage V1.

When the sustain pulse generated during the sustain period of the m-th subfield ends at the negative voltage −Vs such that positive charges are accumulated around the scan electrode Y and negative charges are accumulated around the sustain electrode Z, a pulse sharply rising to the sustain voltage Vs is applied to the scan electrode Y such that a strong discharge occurs during the reset period.

Further, when the sustain pulse generated during the sustain period of the m-th subfield ends at the negative voltage −Vs, and then the second pulse gradually rising from the ground level voltage GND to the sustain voltage Vs with the first slope is applied to the scan electrode Y, a weak discharge occurs during the reset period.

When the second pulse having the second slope that is less than the first slope is applied to the scan electrode Y such that the gradually rising voltage of the second pulse reaches a firing voltage, a dark discharge (i.e., a townsend discharge) occurs. There is little light inside the discharge cells during the generation of the dark discharge.

As a current generated by the dark discharge charges capacitances of the electrodes, a negative feedback phenomenon for reducing magnitudes of the voltage applied to the discharge cells occurs.

Accordingly, the voltage applied to the discharge cells is maintained at the firing voltage such that a state of the dark discharge continues. In a case where the slope of the rising pulse is sharp, the voltage applied to the discharge cells is more than the firing voltage such that a glow discharge emitting light occurs.

Therefore, the first and second slopes are set so that the dark discharge occurs during the reset period.

During the application of the rising pulse including the second pulse to the scan electrode Y, a pulse having a predetermined voltage is applied to the address electrode X.

The predetermined voltage applied to the address electrode X may be equal to the data voltage Va of the data pulse. The reason is to apply the predetermined voltage without a separate voltage source.

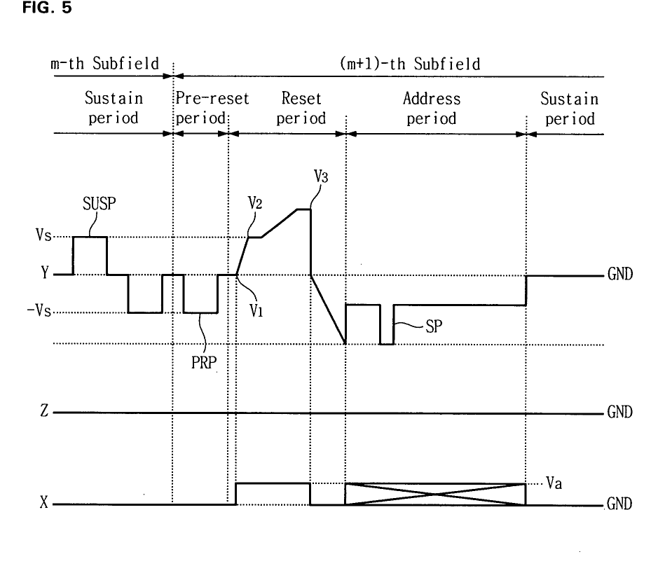

FIG. 5 illustrates a driving waveform generated by a driving method of a plasma display apparatus according to a second embodiment.

Characteristics of the driving waveform described in the second embodiment identical or equivalent to the characteristics of the driving waveform described in the first embodiment is briefly made or is entirely omitted.

In the driving waveform illustrated in FIG. 5, a pre-reset pulse PRP of a negative polarity is applied to the scan electrode Y during a pre-reset period prior to a reset period.

In this case, positive charges are accumulated around the scan electrode Y and negative charges are accumulated around the sustain electrode Z at a start time point of the reset period.

A rising pulse including a second pulse is applied to the scan electrode Y during the reset period. The second pulse gradually rises from a first voltage V1 (for example, a ground level voltage GND) to a second voltage V2 (for example, a sustain voltage Vs) with a first slope, and then gradually rises from the second voltage V2 to a third voltage V3 with a second slope. Accordingly, a magnitude of the highest voltage (i.e., the third voltage V3) of the rising pulse is reduced, and the generation of black light is reduced by maintaining a state of a dark discharge.

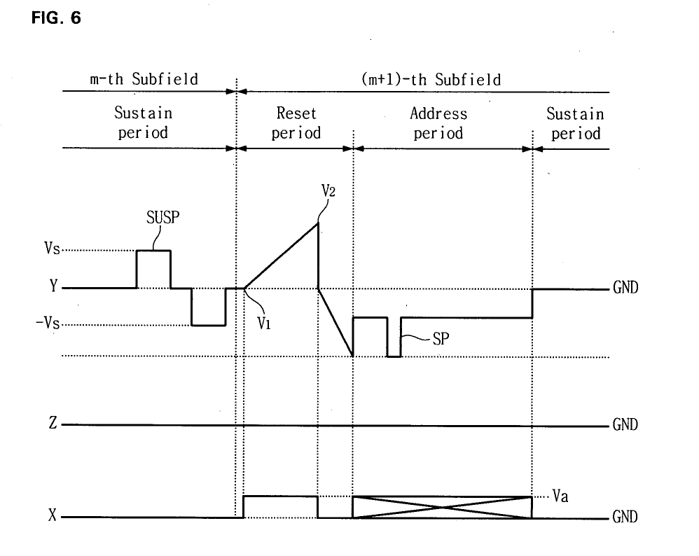

FIG. 6 illustrates a driving waveform generated by a driving method of a plasma display apparatus according to a third embodiment.

Characteristics of the driving waveform described in the third embodiment identical or equivalent to the characteristics of the driving waveform described in the first embodiment is briefly made or is entirely omitted.

Unlike the driving waveform illustrated in FIG. 4, a rising pulse applied during a reset period gradually rises from a first voltage V1 (for example, a ground level voltage GND) to a second voltage V2 with one slope in FIG. 6.

In the related art, a rising pulse applied during a reset period sharply risen to a sustain voltage Vs and then gradually risen to a predetermined voltage, thereby generating a strong discharge.

However, in the driving waveform illustrated in FIG. 6, when a sustain period of an m-th subfield ends at a negative voltage −Vs, the rising pulse gradually rising from the ground level voltage GND to the second voltage V2 with one slope is applied during the reset period. Accordingly, a magnitude of the highest voltage (i.e., the second voltage V2) of the rising pulse is reduced, and black light generated by the rising pulse during the reset period is reduced.

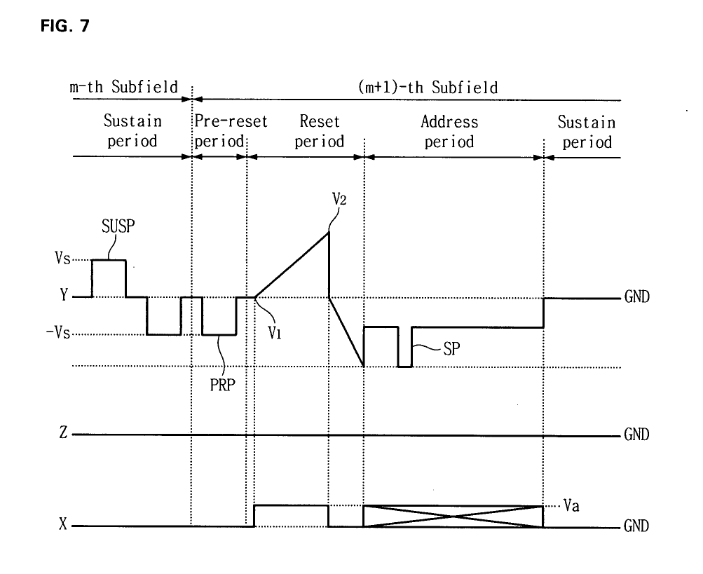

FIG. 7 illustrates a driving waveform generated by a driving method of a plasma display apparatus according to a fourth embodiment.

Characteristics of the driving waveform described in the fourth embodiment identical or equivalent to the characteristics of the driving waveform described in the second embodiment is briefly made or is entirely omitted.

Unlike the driving waveform illustrated in FIG. 5, a rising pulse applied during a reset period gradually rises from a first voltage V1 (for example, a ground level voltage GND) to a second voltage V2 with one slope in FIG. 7.

In the related art, a rising pulse applied during a reset period sharply risen to a sustain voltage Vs and then gradually risen to a predetermined voltage, thereby generating a strong discharge.

However, in the driving waveform illustrated in FIG. 7, when a sustain period of an m-th subfield ends at a negative voltage −Vs, the rising pulse gradually rising from the ground level voltage GND to the second voltage V2 with one slope is applied during the reset period.

Accordingly, a magnitude of the highest voltage (i.e., the second voltage V2) of the rising pulse is reduced, and black light generated by the rising pulse during the reset period is reduced.

As described above, the driving method of the plasma display apparatus according to the embodiments lowers the highest voltage of the rising pulse applied during the reset period, reduces the generation of black light, and secures high margin in the driving of the plasma display apparatus.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A method of driving a plasma display apparatus comprising:
applying a first pulse of a negative polarity to a scan electrode prior to a reset period; and
applying a second pulse to the scan electrode during the reset period, the second pulse gradually rising from a first voltage to a second voltage with a first slop and then gradually rising from the second voltage to a third voltage with a second slope, wherein the first slope is different from the second slope.

2. The method of claim 1, wherein the first slope is more than the second slope.

3. The method of claim 1, further comprising applying a sustain pulse alternately having a positive voltage and a negative voltage to the scan electrode during a sustain period.

4. The method of claim 3, wherein the first pulse is the sustain pulse having the negative voltage applied to the scan electrode during the sustain period.

5. The method of claim 1, wherein the first pulse is a pre-reset pulse applied to the scan electrode during a pre-reset period prior to the reset period.

6. The method of claim 3, wherein the second voltage is substantially equal to the positive voltage of the sustain pulse.

7. The method of claim 1, wherein the first voltage is substantially equal to a ground level voltage.

8. The method of claim 1, wherein a difference between the third voltage and the second voltage is less than a difference between the second voltage and the first voltage.

9. The method of claim 1, wherein a ground level voltage is applied to a sustain electrode.

10. The method of claim 1, wherein a pulse having a predetermined voltage is applied to an address electrode during the application of the second pulse.

11. The method of claim 10, wherein the predetermined voltage is substantially equal to a data voltage of a data pulse applied to the address electrode during an address period.

12. A method of driving a plasma display apparatus comprising:
applying a first pulse of a negative polarity to a scan electrode prior to a reset period; and
applying a second pulse gradually rising from a first voltage to a second voltage to the scan electrode during the reset period.

13. The method of claim 12, wherein the first voltage is substantially equal to a ground level voltage.

14. The method of claim 12, further comprising applying a sustain pulse alternately having a positive voltage and a negative voltage to the scan electrode during a sustain period.

15. The method of claim 14, wherein the first pulse is the sustain pulse having the negative voltage applied to the scan electrode during the sustain period.

16. The method of claim 12, wherein the first pulse is a pre-reset pulse applied to the scan electrode during a pre-reset period prior to the reset period.

17. The method of claim 12, wherein a ground level voltage is applied to a sustain electrode.

18. The method of claim 12, wherein a pulse having a predetermined voltage is applied to an address electrode during the application of the second pulse.

19. The method of claim 18, wherein the predetermined voltage is substantially equal to a data voltage of a data pulse applied to the address electrode during an address period.
